(19) United States
(12) Patent Application Publication
(10) Pub. No.: US 2015/0020449 A1
(43) Pub. Date: Jan. 22, 2015

(54) SIMULATED PALM TREE TRUNK PLANTER

(71) Applicant: Glen R. SUCHECKI, Wall Township, NJ (US)

(72) Inventor: Glen R. SUCHECKI, Wall Township, NJ (US)

(21) Appl. No.: 13/946,923

(22) Filed: Jul. 19, 2013

(51) Int. Cl. A01G 9/02

(52) U.S. Cl. CPC A01G 9/02; A01G 9/021
USPC 47/65.7; 47/65.5

(57) ABSTRACT

The simulated palm tree trunk planter combines the head of a living palm tree with a faux trunk and trunk top that simulates the trunk and trunk top of a real palm tree. This arrangement permits the tree to assume a relatively tall, mature status without the long growing period required. The faux trunk and trunk top are fabricated from molded plastic and can be designed to simulate any of the various species of popular landscape palm trees. The trunk top is provided with an open cavity adapted to receive the head of a living palm tree.

### BACKGROUND OF THE INVENTION

1. Field of the Invention

The present invention generally relates to decorative landscaping structures, and particularly to a simulated palm tree trunk planter that provides an artificial palm tree trunk that serves as a planter for a live palm tree.

2. Description of the Related Art

Palm trees are very popular for use in landscaping, providing exotic, unparalleled beauty to the immediate environment. Palm trees are evergreens and are generally indigenous to tropical climates, although some varieties have been developed that can thrive in more northern climes. There are around 3,000 species of palm trees, and each is provided with a distinctive trunk, trunk top, and frond or leaf The taller species of palm trees are aesthetically best suited for landscaping. Unfortunately, the most desired landscaping species are slow-growing and can require as long as twenty years to reach the maturity and height to create an aesthetically pleasing landscape plant. There have been attempts in the related art to provide simulated palm trees. However, the related art trees lack the look of authenticity and are immediately recognized as fake. A supporting structure that gives a young palm the height and appearance of a mature tree would certainly be a welcome addition to the landscaping industry. Thus, a simulated palm tree trunk planter solving the aforementioned problems is desired.

### SUMMARY OF THE INVENTION

The simulated palm tree trunk planter combines a living, immature palm tree plant with a planter that simulates the trunk and trunk top of a real palm tree. This arrangement permits the composite tree to assume a relatively tall, mature status without the long growing period required. The faux trunk and trunk top are fabricated from molded plastic and can be designed to simulate any of the various species of popular landscape palm trees. The trunk top is provided with an open cavity adapted to receive the living palm tree plant. The trunk can be adorned with openings for lights or designed as a tiki mask and the like.

Accordingly, the invention presents a landscaping structure that is designed to simulate the trunk of a palm tree. The imitation components are designed to simulate the species of a living palm tree plant. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a first embodiment of a simulated palm tree trunk planter according to the present invention.

FIG. 2 is a partial, environmental view of the simulated palm tree trunk planter of FIG. 1.

FIG. 3 is an exploded perspective view of a second embodiment of a simulated palm tree trunk planter according to the present invention.

FIG. 4A is a partial front view of a third embodiment a simulated palm tree trunk planter according to the present invention.

FIG. 4B is a partial front view of a fourth embodiment a simulated palm tree trunk planter according to the present invention.

Similar reference characters denote corresponding features consistently throughout the attached drawings.

### DETAILED DESCRIPTION OF THE PREFERRED EMBODIMENTS

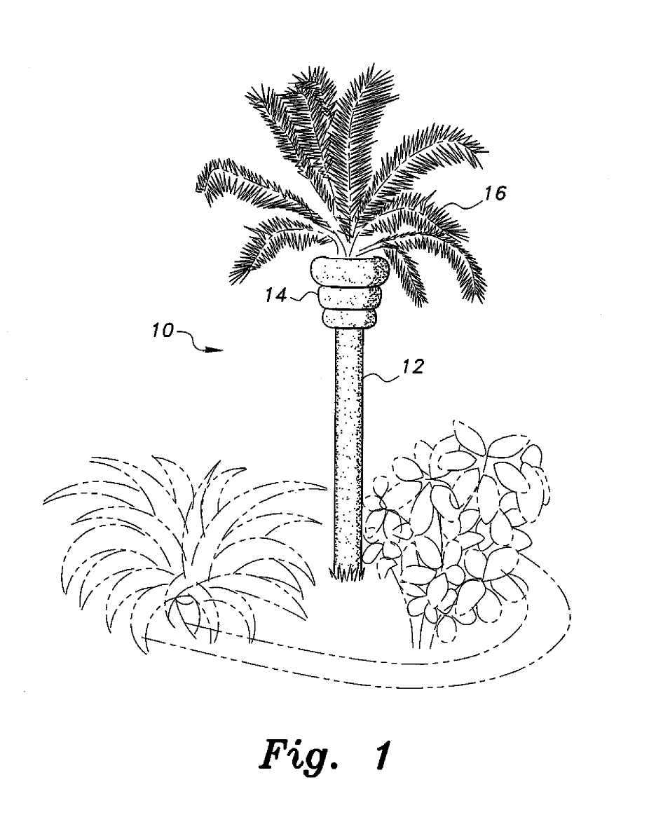

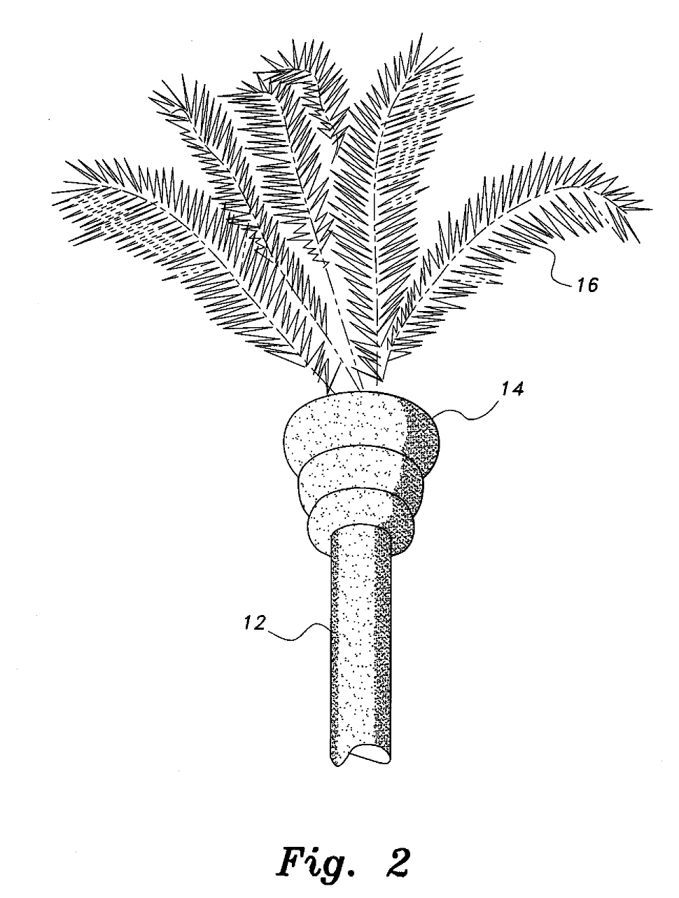

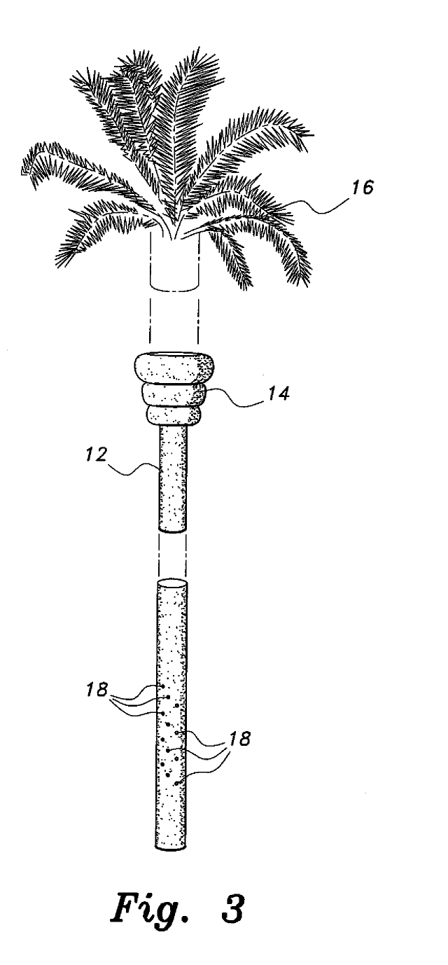

With reference to FIGS. 1-3, the simulated palm tree is generally indicated at 10. The simulated palm tree comprises a trunk 12, a trunk top 14 and a living palm tree member 16. The trunk 12 is fabricated from a lightweight, tubular material (preferably a plastic material) that can be molded to simulate the trunk of various species of palm trees and can be made in sections (as shown in FIG. 3) that are fastened together end to end when assembled. The fastening technique may take on any of several conventional forms (screwing, gluing, etc.), so long as such techniques do not disrupt the look of the trunk surface and provide for a secure connection. In like manner, the trunk top 14 is also fabricated from plastic and may be removably fastened to the upper end of the trunk 12. This arrangement permits a disassembled tree to be conveniently packed for shipping. Openings 18 can be provided in the trunk, if desired, to exhibit lights (not shown) for an enhanced decorative effect.

The palm tree member 16 comprises a living palm tree head that includes fronds or leaves. The member 16 must be properly watered and fed. The trunk top 14 is provided with a cavity for receiving the living member 16 therein. Thus, the trunk top 14 functions as a container or planter for the living member 16.

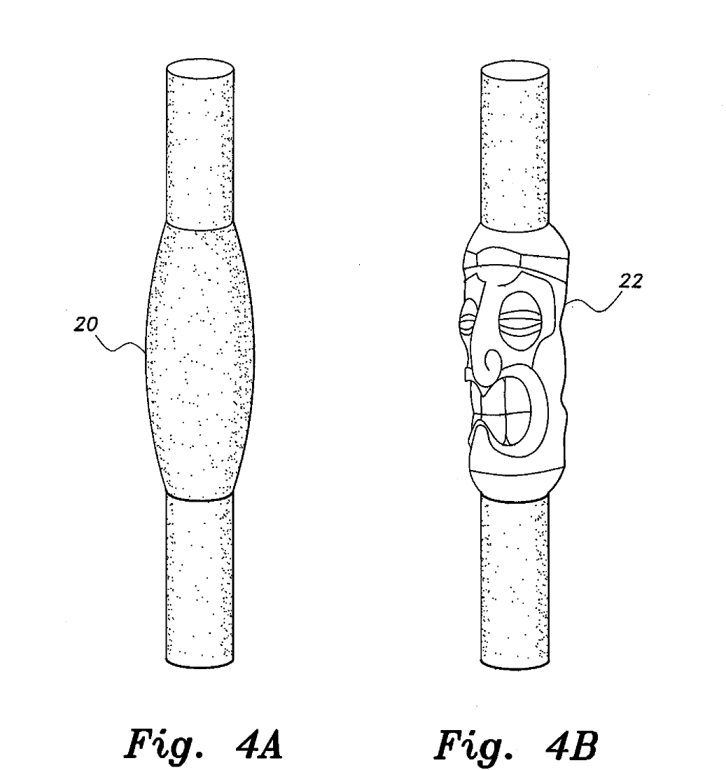

FIGS. 4A and 413 illustrate two of the many designs that the trunk may have. For example, the trunk 20 is configured in the shape of a royal palm tree, whereas the trunk 22 is molded to simulate one of the Tiki masks that are carved into many palms in Polynesia. It is emphasized that the trunk and top can be designed to simulate any species or type of palm tree.

It is to be understood that the present invention is not limited to the embodiments described above, but encompasses any and all embodiments within the scope of the following claims.

I claim:

1. A simulated palm tree trunk planter for landscaping, comprising:
a plurality of lightweight, tubular, hollow sections assembled to form an elongate trunk member, the trunk member having an upper end and being designed to simulate the trunk of a palm tree; and
a top member removably attached to the upper end of the elongate trunk member, the top member being designed to simulate the top of a palm tree, the top member having a cavity formed therein dimensioned and configured for receiving a live palm tree plant.

2. The planter for landscaping according to claim 1, wherein said tubular, hollow sections are fabricated from a molded, plastic material.

3. The planter for landscaping according to claim 1, wherein said top member is fabricated from a molded, plastic material.

4. The planter for landscaping according to claim 1, further including a plurality of openings defined in said elongate trunk.

5. A planter for landscaping, comprising:
a plurality of lightweight, tubular, hollow sections fabricated from molded plastic and assembled end-to-end to form an elongate trunk member, the trunk member having an upper end and being designed to simulate the trunk of a palm tree;
a top member removably attached to the upper end, the top member being fabricated from a molded plastic material and designed to simulate the top of a palm tree, the top member having a cavity formed therein; and
a living, immature palm tree removably positioned in the cavity.

6. The planter for landscaping according to claim 5, further including a plurality of openings defined in said elongate trunk.
